(19) United States
(12) Patent Application Publication
(10) Pub. No.: US 2007/0194693 A1
(43) Pub. Date: Aug. 23, 2007

(54) Light-Emitting Device

(76) Inventors: Hajime Saito, Tenri-shi (JP); Mototaka Taneya, Nara-shi (JP); Takayuki Yuasa, Ikoma-gun (JP); Tatsuya Ryowa, Nara-shi (JP); Setsuhisa Tanabe, Kyoto-shi (JP); Yoichiu Kawakami, Kusatsu-shi (JP); Shizuo Fujita, Soraku-gun (JP); Mitsuru Funato, Kyoto-shi (JP)

Correspondence Address: BIRCH STEWART KOLASCH & BIRCH, PO BOX 747, FALLS CHURCH, VA, 22040-0747, US

(21) Appl. No.: 10/594,249

(22) PCT Filed: Mar. 22, 2005
(86) PCT No.: PCT/JP05/05103

§ 371 Date: Sep. 25, 2006

(30) Foreign Application Priority Data
Mar. 26, 2004 (JP) 2004-092961

(51) Int. Cl. H01J 1/62; H01J 63/04

(52) U.S. Cl. 313/503

(57) ABSTRACT

Disclosed is a light-emitting device comprising a semiconductor excitation light source emitting blue-violet light and a solid material illuminant having an absorbent for the blue-violet light containing samarium (Sm). With such a constitution, the light-emitting device has high efficiency, long life and excellent color rendering properties.

### TECHNICAL FIELD

The present invention relates to a light-emitting device, and more particularly, it relates to a light-emitting device emitting visible light or white light employed for illumination.

### BACKGROUND ART

In general, an attempt is made to obtain visible multicolor light or white light by exciting a phosphor with a solid excitation light source as a visible light-emitting device. For example, Patent Literature 1 discloses a light-emitting device obtaining visible or white light with an excitation light source formed by a broad area laser employing a GaN-based semiconductor and a phosphor of YAG (yttrium aluminum garnet) activated with a rare earth element. The term “GaN-based semiconductor” denotes semiconductors containing nitrides of Ga, Al and In which are group III elements and mixed crystals thereof.

Patent Literature 1: Japanese Patent Laying-Open No. 2002-9402

### DISCLOSURE OF THE INVENTION

### Problems to be Solved by the Invention

While a phosphor (rare earth-activated phosphor) activated with a rare earth element as a luminescent material is excellent in luminous efficiency and color purity, most rare earth elements have main absorption bands in the ultraviolet region shorter than 380 nm and hence an ultraviolet excitation light source is necessary in order to efficiently excite such a phosphor. If excitation light includes ultraviolet light, however, general-purpose resin (epoxy or acrylic resin, for example) normally used as a dispersive medium for the luminescent material is so easily degraded by the ultraviolet light that the reliability of a light-emitting device employing the same is reduced, and it is not preferable to employ ultraviolet light as an excitation light source.

On the other hand, a GaN-based semiconductor light-emitting element has frequently been utilized as a solid excitation light source having a small size and a long life. However, the GaN-based semiconductor light-emitting element has high external quantum efficiency of blue-violet light of 380 to 450 nm, and has the maximum value of external quantum efficiency substantially at 405 nm in particular. Therefore, excitation efficiency of the GaN-based semiconductor light-emitting element is extremely low as an excitation light source for the aforementioned rare earth element-activated phosphor.

While a technique of preparing a luminous layer from AlGaN to have a wide gap is conceivably employed so that a GaN-based semiconductor emits light in the ultraviolet region shorter than 380 nm, an AlGaN luminous layer has low luminous efficiency, includes a large number of defects due to difficulty in crystal growth, and is inferior in reliability.

As hereinabove described, a light-emitting device exciting a rare earth-activated phosphor with a GaN-based semiconductor light-emitting element had problems in the points of luminous efficiency and reliability.

The present invention has been proposed in order to solve the aforementioned problems, and an object of the present invention is to provide a light-emitting device having high efficiency, a long life and excellent color rendering.

### MEANS FOR SOLVING THE PROBLEMS

The light-emitting device according to the present invention comprises a semiconductor excitation light source emitting blue-violet light and a solid material illuminant having an absorbent for the said blue-violet light containing samarium (Sm).

The said blue-violet light preferably has a peak wavelength in the range of 398 to 412 nm.

The semiconductor excitation light source emitting the said blue-violet light in the light-emitting device according to the present invention is preferably a semiconductor laser device having an active layer of an InGaN semiconductor.

The said solid material illuminant in the light-emitting device according to the present invention preferably contains Sc, Y or a typical element as cations, and contains at least one of N, O and S as anions. In particular, the solid material illuminant more preferably (1) contains both N and O as anions, (2) contains at least one of nitrides of Ga, In and Al, or (3) contains at least one of oxides of Y, Si, Al and Zn.

The solid material illuminant in the light-emitting device according to the present invention preferably contains a red phosphor having a peak wavelength in the range of 600 to 670 nm, a green phosphor having a peak wavelength in the range of 500 to 550 nm and a blue phosphor having a peak wavelength in the range of 450 to 480 nm.

The said red phosphor, the said green phosphor and the said blue phosphor in the solid material illuminant more preferably contain rare earth elements.

Further, the red phosphor in the solid material illuminant particularly preferably contains at least either Sm or Eu.

### EFFECTS OF THE INVENTION

The light-emitting device according to the present invention basically comprises the semiconductor excitation light source emitting blue-violet light and the solid material illuminant excited by this semiconductor excitation light source, and this solid material illuminant has the light absorbent containing Sm. Sm, having the peak of light absorption around 405 nm, absorbs the blue-violet excitation light with high efficiency. Therefore, a light-emitting device exciting an illuminant with high efficiency can be implemented by comprising such a semiconductor excitation light source and the solid material illuminance. According to this inventive light-emitting device, a light-emitting device remarkably higher in efficiency and longer in life as compared with the prior art and excellent in color rendering can be provided.

In the light-emitting device according to the present invention, the said blue-violet light has the peak wavelength in the range of 398 to 412 nm so that the emission peak wavelength substantially overlaps with the absorption peak wavelength of Sm, whereby Sm can efficiently absorb the excitation light.

When the semiconductor excitation light source emitting the said blue-violet light is a semiconductor light-emitting element having an emission layer of an InGaN semiconductor, the emission spectrum substantially coincides with the absorption peak spectrum of Sm and the light-emitting element has high external quantum efficiency with the maximum value of the external quantum efficiency at 405 nm, whereby the maximum luminous efficiency can be obtained with the minimum power. When the light-emitting element is a semiconductor laser device, the absorption peak of Sm can be efficiently excited due to a narrow spectral line width of lasing.

In the light-emitting device according to the present invention, the said solid material illuminant contains Sc, Y or a typical element as cations and contains at least one of N, O and S as anions, so that absorption efficiency of Sm and luminous efficiency of the illuminant can be increased.

When containing both N and O as anions, the said solid material illuminant can have chemical stability and a low-loss property of a nitride host material and productivity of an oxide host material, so that a light-emitting device excellent in luminous efficiency and cost performance can be implemented.

When the said solid material illuminant contains at least one of nitrides of Ga, In and Al, the absorption efficiency of Sm and the luminous efficiency can be further improved. Further, a nitride is so chemically stable that a light-emitting device excellent in reliability can be implemented.

When the said solid material illuminant contains at least one of oxides of Y, Si, Al and Zn, the absorption efficiency of Sm and the luminous efficiency can be improved. Particularly when Sm is employed also as a red phosphor as described later, a peak of 650 nm having high red purity can be employed as a main wavelength, so that excellent color rendering can be obtained by improving a color temperature in white light.

In the light-emitting device according to the present invention, the said solid material illuminant preferably contains the red phosphor having the peak wavelength in the range of 600 to 670 nm, the green phosphor having the peak wavelength in the range of 500 to 550 nm and the blue phosphor having the peak wavelength in the range of 450 to 480 nm. Thus, white light having a high color temperature can be obtained, so that an illuminator excellent in color rendering can be manufactured as a result.

Further, the said red phosphor, the said green phosphor and the said blue phosphor contain rare earth elements, whereby the three primary colors (R, G and B) constituting the white light can be advantageously simply obtained.

When the said red phosphor contains at least either Sm or Eu, red light having high color purity and high luminous efficiency can be obtained. Particularly in the case of obtaining white light, efficiency of the white light can be improved when the red phosphor contains Sm and Eu, since red light is inferior in luminous efficiency as compared with blue-violet light.

### BRIEF DESCRIPTION OF THE DRAWINGS

FIG. 1 is a structural sectional view showing a light-emitting device 100 according to a first preferred example of the present invention in a simplified manner.

FIG. 2 illustrates an excitation spectrum and an emission spectrum of Sm activated as an absorbent in the light-emitting device according to the present invention.

FIG. 3 is a structural perspective view showing a light-emitting device 201 according to a second preferred example of the present invention in a simplified manner.

FIG. 4 is a structural perspective view showing a light-emitting device 301 according to a third preferred example of the present invention in a simplified manner.

### DESCRIPTION OF THE REFERENCE SIGNS

100, 201, 301 light-emitting device, 102, 205, 305 blue-violet light-emitting element, 103, 204, 306 Sm light absorbent, 104, 205, 307 phosphor, 105, 202, 304 illuminant.

### BEST MODES FOR CARRYING OUT THE INVENTION

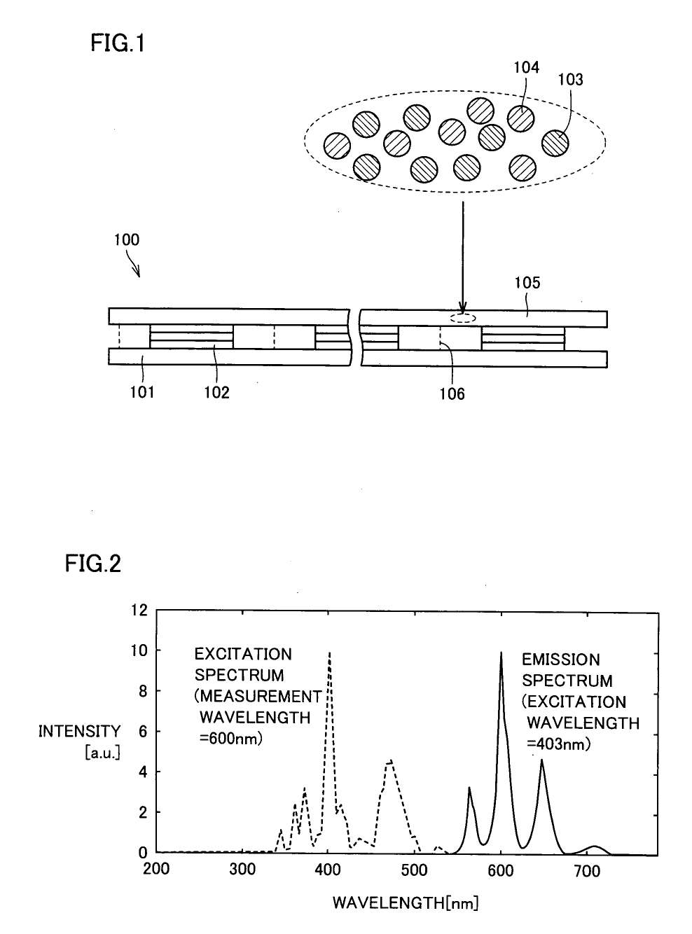

FIG. 1 is a structural sectional view showing a light-emitting device 100 according to a first preferred example of the present invention in a simplified manner. FIG. 2 illustrates an excitation spectrum and an emission spectrum of Sm activated as an absorbent in the light-emitting device according to the present invention. Light-emitting device 100 according to the present invention basically comprises a semiconductor excitation light source (hereinafter simply referred to as “blue-violet light-emitting element”) 102 emitting blue-violet light and a solid material illuminant (hereinafter simply referred to as “illuminant”) 105 having a light absorbent (hereinafter referred to as “Sm light absorbent”) 103 which contains samarium and is excited by absorbing the said blue-violet light. Sm light absorbent 103 may be formed by samarium atoms, or may be in the state of particles activated with a proper host material. Sm has an absorption peak around 405 nm, as shown in FIG. 2. In the light-emitting device according to the present invention, the blue-violet light-emitting element is employed as the light source exciting the illuminant having such an Sm light absorbent. The blue-violet light emitted by the blue-violet light-emitting element is absorbed by Sm contained in the illuminant so that this absorbed light energy is radiated by inner-shell transition of Sm, leading to extremely small loss. According to the inventive light-emitting device having this structure, a light-emitting device remarkably higher in efficiency and longer in life as compared with the prior art and excellent in color rendering can be provided. In light-emitting device 100 according to the present invention, illuminant 105 may contain a luminous material (at least one material selected from rare earth elements such as La, Ce, Pr, Nd, Eu, Gd, Tb, Dy, Ho, Er, Tm, Yb and Lu and transition elements such as Mn, Cr, V and Ti, for example) other than Sm, for obtaining light by transiting absorption energy to this luminous material also from Sm. Also in this case, higher luminous efficiency as compared with the prior art can also be obtained due to the high blue-violet light absorptivity.

The content (activation concentration) of Sm in the said illuminant, which is not particularly restricted, is preferably 0.01 to 10 mol %, more preferably 0.1 to 5 mol %, and particularly preferably 0.1 to 0.2 mol %. This is because there is such a tendency that blue-violet excitation light cannot be sufficiently absorbed if the content of Sm is less than 0.01 mol % while there is such a tendency that light absorption and light mutually influence between Sm atoms to reduce luminous efficiency if the content of Sm exceeds 10 mol %. When Sm is employed also as a red phosphor as described later, the illuminant further preferably contains Sm in the range of 0.1 to 10 mol % in a quantity exceeding the aforementioned range. A light-emitting device containing Sm having activation concentration in this range can be implemented by homogeneously dispersing fine particles of the material of illuminant 105 prepared by adding an Sm compound such as samarium oxide, samarium chloride or samarium nitride in this concentration range and baking the same into a substrate of glass or resin. Alternatively, a target may be prepared by sintering powder of the material for illuminant 105 to which an Sm compound is added in this concentration range, for forming a thin film by a well-known thin film forming method such as laser ablation or sputtering.

The blue-violet light-emitting element employed as the light source in the present invention preferably has an emission peak at the absorption peak spectrum of Sm. Thus, the emission peak wavelength of the blue-violet light-emitting element substantially overlaps with the absorption peak wavelength of Sm, whereby Sm can efficiently absorb the excitation light in the illuminant. More specifically, the blue-violet light in the present invention preferably has the peak wavelength in the range of 398 to 412 nm. If the peak wavelength is out of this range, most part of the excitation light is not absorbed by Sm, and hence luminous efficiency may be reduced.

As a blue-violet light-emitting element capable of implementing the peak wavelength in the said range, a GaN-based semiconductor which is a nitride, a ZnO-based semiconductor which is an oxide or a ZnSSe-based semiconductor which is a group II-IV compound semiconductor can be employed as an emission layer. While a GaN-based semiconductor light-emitting element is more specifically prepared from GaN, AlN, InN, GaInN, AlInN, AlGaN or AlGaInN, B may be included in a group III element, or a group V element (P, As, Sb or Bi) other than N may also be included. In particular, a semiconductor light-emitting element employing an InGaN semiconductor frequently utilized as a blue-violet light emitting element in recent years as an emission layer, having an emission spectrum substantially coinciding with the absorption peak spectrum of Sm and exhibiting high external quantum efficiency as a light-emitting element with the maximum value of external quantum efficiency at 405 nm, can preferably obtain the maximum luminous efficiency with the minimum power.

While a solid laser, a gas laser, a semiconductor laser device, a light-emitting diode or a wavelength conversion element employing second harmonic can be employed as the blue-violet light-emitting element, a laser device capable of efficiently exciting the absorption peak of Sm with a narrow emission spectrum line width is preferably employed. In particular, it is particularly preferable to have a semiconductor laser device having an InGaN semiconductor as an active layer. Further, an end emission or face emission laser device is preferable.

The illuminant in the light-emitting device according to the present invention contains a medium having a function of carrying an Sm light absorbent and an emission center material. This medium also has a function of controlling the crystal fields of the Sm light absorbent and the illuminant for optimizing absorption and emission wavelengths, in addition to the aforementioned function. Further, it is important that the medium employed for the illuminant transmits the excitation light from the blue-violet light-emitting element with low loss. A material (inorganic solid material) containing Sc, Y or a typical element as cations and containing at least one of N, O and S as anions is preferable as the medium contained in the illuminant according to the present invention. For example, GaN, AlN, InGaN, InAlN, InGaAlN, Si₃N₄, GaNP, AlNP, InGaNP, InAlNP, InGaAlNP, GaNAs, AlNAs, InGaNAs, InAlNAs, InGaAlNAs, GaNAsP, AlNAsP, InGaNAsP, InAlNAsP, InGaAlNAsP, ZnO, MgO, ZnCdO, ZnMgO, ZnCdMgO, ZnS, ZnSe, ZnSSe, Y₂O₃, Al₂O₃, SiO₂, Ga₂O₃, Sc₂O₃, In₂O₃, Si_{6-z}Al_{z}(O,N)_{8-z}(O<z≦4.2) or Mₓ(Si,Al,Ga)₁₂(O,N)₁₆ (M denotes a metallic element, 0<x≦2) can be listed as such a material for the illuminant.

According to the present invention, the medium contains Sc, Y or a typical element as cations, so that an effect of improving luminous efficiency of the emission center material can be attained. When the medium contains N as anions, an illuminant utilizing chemical stability and a low-loss property of a nitride host material can be utilized, so that an efficient light-emitting device further improved in absorption efficiency of the Sm light absorbent and luminous efficiency of the illuminant can advantageously be implemented. When the medium contains O as anions, high productivity of an oxide host material can be utilized, so that a light-emitting device having excellent absorption efficiency of the Sm light absorbent and excellent luminous efficiency of the illuminant with excellent cost performance can advantageously be implemented.

The medium employed for the illuminant according to the present invention is more preferably any of the following (1) to (3) among the above:

(1) contains both N and O as anions.

(2) contains at least one of nitrides of Ga, In and Al.

(3) contains at least one of oxides of Y, Si, Al and Zn.

When (1) the material containing both N and O as anions is employed as the medium according to the present invention, both of the chemical stability and the low-loss property of the nitride host material and the productivity of the oxide host material can be attained, so that a light-emitting device excellent in luminous efficiency and cost performance can be implemented. For example, Si_{6-z}Al_{z}(O,N)_{8-z}(O<z≦4.2) and Mₓ(Si,Al,Ga)₁₂(O,N)₁₆ (M denotes a metallic element, 0<x≦2) can be listed as such materials among those illustrated in the above.

When (2) the material containing at least one of nitrides of Ga, In and Al is employed as the medium according to the present invention, the absorption efficiency of the Sm light absorbent and the luminous efficiency can be further improved. Further, a nitride is so chemically stable that a light-emitting device excellent in reliability can be implemented. For example, GaN, AlN, InGaN, InAlN and InGaAlN can be listed as such materials among those illustrated in the above.

When (3) the material containing at least one of oxides of Y, Si, Al and Zn is employed as the medium according to the present invention, the absorption efficiency of the Sm light absorbent and the luminous efficiency can be improved. Particularly when Sm is employed also as a red phosphor as described later, a peak of 650 nm having high red purity can be employed as a main wavelength, so that excellent color rendering can be obtained by improving a color temperature in white light. For example, ZnO, ZnCdO, ZnMgO, ZnCdMgO, ZnS, ZnSe, Y₂O₃, Al₂O₃ and SiO₂ can be listed as such materials among those illustrated in the above.

The said medium is preferably prepared from a material having small phonon energy in order to reduce the rate of multiphonon relaxation resulting in energy loss in emission of the illuminant, and preferably prepared from a solid material having high crystal field asymmetry in order to increase 650 peak emission excellent in color purity particularly when the Sm light absorbent is employed as a red phosphor. From this point of view, (2) the material containing at least one of nitrides of Ga, In and Al or (3) the material containing at least one of oxides of Y, Si, Al and Zn is particularly preferable as the medium among those illustrated above. Further, the medium according to the present invention may contain a plurality of materials of those described above. In particular, a metal oxynitride material containing at least one of Ga, In, Al, Y, Si and Zn as cations and having both N and O as anions has such a remarkable effect that a light-emitting device having both of the advantage resulting from employment of the aforementioned cations and the advantage resulting from employment of N and O as the aforementioned anions can be implemented.

The illuminant according to the present invention may alternatively be prepared by employing organic resin containing at least any material selected from epoxy resin, silicon resin, polycarbonate resin and acrylic resin as the medium in place of the aforementioned inorganic solid material. When organic resin is employed as the medium, an illuminant excellent in dispersibility of the said Sm light absorbent (and a phosphor) and excellent in workability can advantageously be obtained. In particular, a medium having low hygroscopicity and excellent dimensional stability can advantageously be obtained when epoxy resin is employed, while a medium having a high transmission property for visible light can advantageously be obtained when acrylic resin is employed. When silicon resin or polycarbonate resin is employed, a medium excellent in durability with respect to blue-violet light can advantageously be obtained. The medium may be prepared by combining the aforementioned organic resin materials with each other, as a matter of course. Further, Sm and the emission center material may be activated with the aforementioned inorganic solid material having the function of controlling the crystal fields and optimizing the absorption and emission wavelengths and dispersed in the organic resin.

Alternatively, glass may be employed as the said medium. Glass is remarkably superior in light transmission property and durability as compared with organic resin, excellent also in dispersibility of the said Sm light absorbent and an emission center material (and a phosphor) and low-priced, whereby a light-emitting device excellent in reliability can advantageously be manufactured at a low cost. Also in this case, the said inorganic solid material activating Sm and the emission center material may be dispersed in glass. Further, such a glass illuminant may be sealed with the aforementioned organic resin, so that durability is remarkably improved.

The illuminant according to the present invention may further contain R, G and B phosphors forming the three primary colors for implementing white light. Such phosphors preferably include a red phosphor having a peak wavelength in the range of 600 to 670 nm (more preferably 600 to 630 nm), a green phosphor having a peak wavelength in the range of 500 to 550 nm (more preferably 530 to 550 nm) and a blue phosphor having a peak wavelength in the range of 450 to 480 nm (more preferably 450 to 470 nm) from such a point of view that white light having a high color temperature with excellent color rendering can be implemented.

The said red phosphor, the said green phosphor and the said blue phosphor, for which well-known proper phosphors having peak wavelengths in the aforementioned ranges can be employed respectively, preferably contain rare earth elements respectively. When these phosphors contain rare earth elements respectively, the three primary colors (R, G and B) constituting white light can be simply obtained.

For example, Sm, Eu, Tb, Tm, La, Ce, Pr, Nd, Gd, Dy, Ho, Er, Yb or Lu can be listed as the rare earth element contained in each phosphor according to the present invention.

The red phosphor preferably contains at least either Sm or Eu as the emission center material among the above. When the red phosphor contains at least either Sm or Eu, red light having high color purity and high luminous efficiency can advantageously be obtained. While the Sm light absorbent is contained in the illuminant as an essential component in the present invention, Sm has a coloring peak around 600 nm, and the Sm light absorbent itself can be employed as a red illuminant. A structure employing Eu having high luminous efficiency and excellent red purity as the emission center material for emitting red light together by energy transition from Sm is also preferable as the red phosphor. Particularly in the case of obtaining white light, efficiency of the white light can also be improved when the red phosphor contains both Sm and Eu since red light is inferior in luminous efficiency as compared with blue-violet light.

The green phosphor preferably contains Er, Eu and/or Tb as the emission center material among the above. When the green phosphor contains Er, Eu and/or Tb, white light advantageously attains excellent color rendering and high luminous efficiency.

The blue phosphor preferably contains Tm or Ce as the emission center material among the above. When the blue phosphor contains Tm or Ce, white light advantageously attains excellent color rendering and high luminous efficiency.

The said red phosphor, the said green phosphor and the said blue phosphor employed in the present invention may contain transition elements such as Mn, Cr, V and/or Ti or transition element organic metal complexes containing the aforementioned rare earth elements, in addition to the aforementioned rare earth elements.

The concentration of the added phosphors according to the present invention is preferably in the range of 0.01 to 10 mol % and more preferably in the range of 0.1 to 5 mol %, similarly to the aforementioned Sm. A light-emitting device containing phosphors added in concentration of this range can be implemented by homogeneously dispersing fine particles of the material for illuminant 105 to which phosphors are added in this range in the medium with Sm, for example. Alternatively, a target may be prepared by sintering powder of the material for illuminant 105 to which phosphors are added in this concentration range with Sm, for forming a thin film by a well-known thin film forming method such as laser ablation or sputtering.

The light-emitting device according to the present invention, whose illuminant preferably contains the said red phosphor, the said green phosphor and the said blue phosphor, may alternatively be implemented as a light-emitting device obtaining arbitrary visible light by containing only any one or two colors of R, G and B, as a matter of course.

In light-emitting device 100 according to the example of the present invention shown in FIG. 1, blue-violet light-emitting element 102 serving as the light source emitting excitation light is arranged on a support substrate 1, and illuminant 105 prepared by homogeneously activating/dispersing Sm light absorbent 103 and three types of phosphors (the aforementioned red, green and blue phosphors) 104 in a medium is arranged thereon. While the size and the arrangement of blue-violet light-emitting element 102 in the light-emitting device according to the present invention are not particularly restricted, FIG. 1 shows an example employing semiconductor laser devices 300 μm square, for example, arranged in the form of an array at regular intervals of 50 μm. The aforementioned inorganic solid material is preferably employed as the medium carrying Sm light absorbent 103 and phosphors 104 in illuminant 105. Support substrate 101 can be prepared from an arbitrary material so far as the same can support blue-violet light-emitting element 102 and illuminant 105, and glass, plastic or ceramics may be employed, for example. A substrate for epitaxial growth of a group III nitride semiconductor such as sapphire can also be employed for support substrate 101, and labor for arranging and wiring blue-violet light-emitting element 102 can be remarkably saved when directly employing a substrate having built-in blue-violet light-emitting element 102 in the form of an array as a support substrate. The example shown in FIG. 1 is provided with a partition 106 partitioning blue-violet light-emitting element 102. The surface of partition 106 is preferably made of a material such as Al, Pt and/or Ag, for example, having high light reflectance, for efficiently reflecting light incident upon this partition 106 toward the medium containing the phosphors.

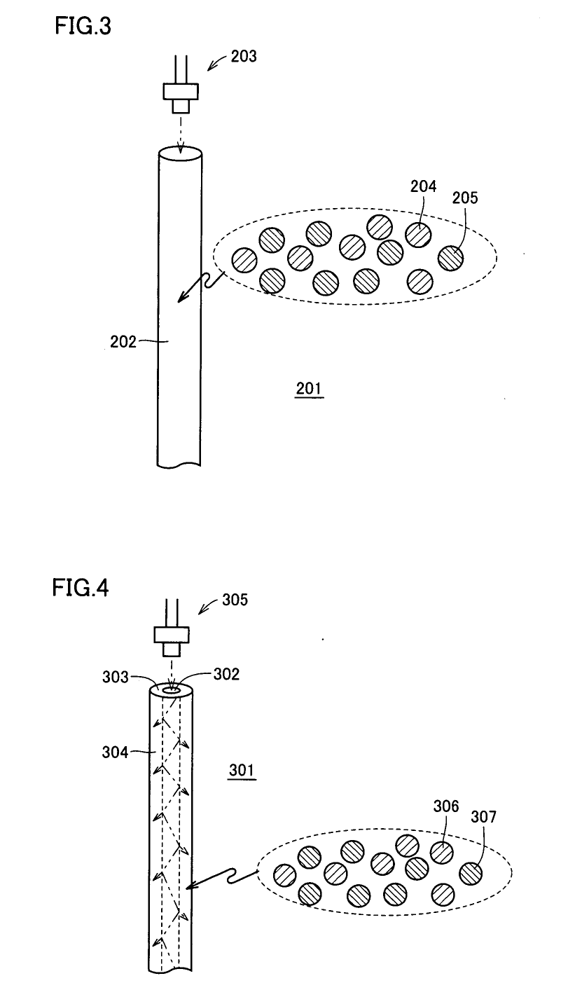

FIG. 3 is a structural perspective view showing a light-emitting device 201 according to a second preferred example of the present invention in a simplified manner. Light-emitting device 201 of the example shown in FIG. 3 basically comprises an illuminant (linear illuminant) 202 prepared by homogeneously activating/dispersing an Sm light absorbent 204 and three types of phosphors 205 in a medium and linearizing the same and a blue-violet light-emitting element 203 arranged to be capable of introducing blue-violet excitation light from an end of this linear illuminant 202. As the medium forming linear illuminant 202, organic resin can also be preferably employed in addition to the aforementioned inorganic solid material. A light-emitting diode or a surface-emission type semiconductor laser device can be employed as blue-violet light-emitting element 203 employed in light-emitting device 201. Light-emitting device 201 of the example shown in FIG. 3 can be employed as a linear white light source.

FIG. 4 is a structural perspective view showing a light-emitting device 301 according to a third preferred example of the present invention in a simplified manner. Light-emitting device 301 of the example shown in FIG. 4 employs an optical fiber member having a core 302 and a cladding 303 as a wavelength conversion part, has a structure (face polarization system) partially leaking excitation light guided through core 302 toward cladding 503, and is formed by homogeneously dispersing a particulate AlN illuminant 304 prepared by activating/dispersing an Sm light absorbent 306 and three types of phosphors 307 in cladding 304. In other words, light-emitting device 301 of the example shown in FIG. 4 utilizes cladding 303 of the optical fiber member as illuminant 304, and light-emitting device 301 having such a structure is also included in the inventive light-emitting device. While the optical fiber member can be prepared from a well-known proper one and is not particularly restricted, an optical fiber member 304 having core 302 of acrylic resin such as PMMA (polymethyl methacrylate) and cladding 303 of vinylidene fluoride or fluororesin such as PTFE (polytetrafluoroethylene) is preferably employed. Effects of the present invention can be attained also when employing glass fiber of fluoride glass, boron glass or silica. Cladding 303 may further contain a light diffuser. Light-emitting device 301 basically comprises a blue-violet light-emitting element 305 arranged to be capable of introducing blue-violet excitation light from an end of illuminant 304 utilizing this optical fiber member. Light-emitting device 301 having this structure, shaped similarly to light-emitting device 201 of the example shown in FIG. 3, can constitute a longer light-emitting device as compared with light-emitting device 201 of the example shown in FIG. 3 for homogeneously emitting light since the excitation light is guided through core part 302 and gradually penetrates into cladding part 303 to contribute to absorption and emission. Light-emitting device 301 of the example shown in FIG. 4 can be employed as a linear white light source, and can also be employed as an illumination light source substitutional for a conventional fluorescent lamp or a flexible sheet light source including the same.

While the present invention is now described in more detail with reference to Examples, the present invention is not restricted to these.

### EXAMPLE 1

Light-emitting device 100 of the example shown in FIG. 1 was prepared in Example 1. AlN which is an inorganic solid material was employed as a medium, Sm was added thereto by 0.2 mol %, and three types of phosphors (red phosphor: Eu-activated Y₂OS, green phosphor: Tb-activated GaN, blue phosphor: Tm-activated Al₂O₃) were added and homogeneously activated/dispersed. More specifically, illuminant 105 in the form of a thin film was formed on support substrate 101 by adding 1 mol % of Sm(NO₃)₃, 3 mol % of Eu-activated Y₂OS, 0.1 mol % of Tb-activated GaN and 1 mol % of Tm-activated Al₂O₃ to AlN powder, homogeneously dispersing the obtained material, thereafter baking the material in a nitrogen atmosphere having a temperature of 1500° C. and ablating the same as a target by laser ablation. Sapphire was employed for support substrate 101. Semiconductor laser devices 300 μm square, including active layers of an InGaN semiconductor having a peak wavelength of 405 nm, were arranged in the form of an array at regular intervals of 50 μm as blue-violet light-emitting element 102, and mounted so that an end of an outgoing surface was directed to illuminant 105. Blue-violet light-emitting element 102 was partitioned by partition 106 of Al.

When a current of 80 mA was fed to blue-violet light-emitting element 102 in light-emitting device 100 according to the present invention having this structure, a laser beam having a wavelength of 405 nm was incident upon illuminant 105 with an output of 30 mW, and white light was obtained from the upper surface of illuminant 105.

When light-emitting device 100 was set in an integrating sphere for measuring the total luminous flux and calculating energy efficiency η by dividing this by power consumption of blue-violet light-emitting element 102 serving as the excitation light source, the result was 80 [lm/W].

The white light was confirmed by color rendering. The average color rendering index Ra of the white light radiated from the inventive light-emitting device was 85, when CIE daylight (color temperature: 5000 K) was employed as a reference illuminant while employing eight colors of red, yellow, yellow-green, green, blue-green, blue-violet, violet and red-violet (lightness: 6, color saturation: 7) as test colors for calculating the color rendering index of light-emitting device 100 as follows:
Rᵢ=100−4.6×ΔEᵢ
(where i is a symbol expressing any of the aforementioned eight test colors, and has a value in the range of 1 to 8) and evaluating color rendering by the total average of the respective color rendering indices as follows:
Ra=Σ(i=1 to 8)Rᵢ×1/8

Since AlN which is a medium also functions as a fluorescent host material, a similar effect was attained also when activating/dispersing only Eu, only Tb and only Tm as red, blue and green phosphors respectively in the aforementioned concentration.

### COMPARATIVE EXAMPLE 1

A light-emitting device was prepared similarly to Example 1 except that no Sm was added. When energy efficiency was evaluated similarly to Example 1, η was 50 [lm/W]. An average color rendering index Ra measured similarly to that of Example 1 was 70.

### EXAMPLE 2

Light-emitting device 201 according to the example shown in FIG. 3 was prepared in Example 2. Acrylic resin was employed as a medium, Sm was added thereto by 0.2 mol %, and three types of phosphors (red phosphor: Eu-activated Y₂OS, green phosphor: Eu-activated 3(Ba,Mg,Mn)O.8Al₂O₃, blue phosphor: Ag-activated ZnS) were added and homogeneously activated/dispersed. More specifically, linear illuminant 202 was formed by adding 1 mol % of metal Sm, 3 mol % of Eu-activated Y₂OS, 0.1 mol % of Eu-activated 3(Ba,Mg,Mn)O.8Al₂O₃ and 1 mol % of Ag-activated ZnS in acrylic resin, thereafter homogeneously dispersing the obtained material and shaping the same into a diameter of 3 mm. A semiconductor laser device including an active layer of an InGaN semiconductor having a peak wavelength of 405 nm was employed as blue-violet light-emitting device 205, and arranged to be capable of introducing blue-violet excitation light from an end of linear illuminant 202.

When a current of 80 mA was fed to blue-violet light-emitting element 205 in light-emitting device 201 according to the present invention having this structure, a laser beam having a wavelength of 405 nm was incident from an end of linear illuminant 202 with an output of 30 mW, and white light was obtained from a side surface of linear illuminant 202 and an end surface opposite to that receiving the laser beam. The white light was confirmed similarly to Example 1.

A similar effect was attained also in a form obtained by replacing Sm with Sm-activated GaN and activating the same with a solid illuminant material.

### EXAMPLE 3

Light-emitting device 301 of the example shown in FIG. 4 was prepared in Example 3. An optical fiber member formed by core 302 and cladding 303 concentrically covering the outer periphery thereof with the cladding prepared by homogeneously dispersing an Sm light absorbent and three types of phosphors (red phosphor: 3 mol % of Zn_{0.1}Cd_{0.9}Se nanoparticles of 8 nm in particle size, green phosphor: 0.1 mol % of In_{0.3}Ga_{0.7}N nanoparticles of 8 nm in particle size, blue phosphor: 1 mol % of InN nanoparticles of 4.5 nm in particle size) in particulate AlN was employed as illuminant 304. In the optical fiber member, the core (guide diameter: 0.2 mm) was prepared from PMMA, the cladding (guide diameter: 0.5 mm) was prepared from PTFE, and the refractive index of cladding 303 was smaller than that of core 302. The polymer ratio between vinylidene fluoride and tetrafluoroethylene in the cladding was so adjusted that part of a laser beam guided through core 302 leaked toward cladding 303. A semiconductor laser device including an active layer of an InGaN semiconductor having a peak wavelength of 405 nm was employed as blue-violet light-emitting element 305, and arranged to be capable of introducing blue-violet excitation light from an end of the optical fiber member.

When a current of 80 mA was fed to blue-violet light-emitting element 305 in light-emitting device 301 according to the present invention having this structure, a laser beam having a wavelength of 405 nm was incident from an end of core 302 with an output of 30 mW, and white light was obtained from cladding 303. The white light was confirmed similarly to Example 1.

### EXAMPLE 4

Light-emitting device 100 of the example shown in FIG. 1 was prepared similarly to Example 1, except that GaN which is an inorganic solid material was employed as a medium. Energy efficiency η and an average color rendering index Ra evaluated similarly to Example 1 were 75 [lm/W] and 85 respectively.

### EXAMPLE 5

Light-emitting device 100 of the example shown in FIG. 1 was prepared similarly to Example 1, except that In_{0.1}Ga_{0.9}N which is an inorganic solid material was employed as a medium. Energy efficiency η and an average color rendering index Ra evaluated similarly to Example 1 were 70 [lm/W] and 80 respectively.

### EXAMPLE 6

Light-emitting device 100 of the example shown in FIG. 1 was prepared similarly to Example 1, except that In_{0.05}Al_{0.1}Ga_{0.85}N which is an inorganic solid material was employed as a medium. Energy efficiency η and an average color rendering index Ra evaluated similarly to Example 1 were 80 [lm/W] and 85 respectively. CL EXAMPLE 7

Light-emitting device 100 of the example shown in FIG. 1 was prepared similarly to Example 1, except that Si₃N₄ which is an inorganic solid material was employed as a medium. Energy efficiency η and an average color rendering index Ra evaluated similarly to Example 1 were 80 [lm/W] and 90 respectively.

### EXAMPLE 8

Light-emitting device 100 of the example shown in FIG. 1 was prepared similarly to Example 1, except that GaN_{0.95}P_{0.05} which is an inorganic solid material was employed as a medium. Energy efficiency η and an average color rendering index Ra evaluated similarly to Example 1 were 80 [lm/W] and 85 respectively.

### EXAMPLE 9

Light-emitting device 100 of the example shown in FIG. 1 was prepared similarly to Example 1, except that AlN_{0.95}PO_{0.05} which is an inorganic solid material was employed as a medium. Energy efficiency η and an average color rendering index Ra evaluated similarly to Example 1 were 85 [lm/W] and 90 respectively.

### EXAMPLE 10

Light-emitting device 100 of the example shown in FIG. 1 was prepared similarly to Example 1, except that In_{0.1}Ga_{0.9}N_{0.95}P_{0.05} which is an inorganic solid material was employed as a medium. Energy efficiency η and an average color rendering index Ra evaluated similarly to Example 1 were 80 [lm/W] and 85 respectively.

### EXAMPLE 11

Light-emitting device 100 of the example shown in FIG. 1 was prepared similarly to Example 1, except that In_{0.1}Al_{0.9}N_{0.95}P_{0.05} which is an inorganic solid material was employed as a medium. Energy efficiency η and an average color rendering index Ra evaluated similarly to Example 1 were 85 [lm/W] and 90 respectively.

### EXAMPLE 12

Light-emitting device 100 of the example shown in FIG. 1 was prepared similarly to Example 1, except that In_{0.05}Al_{0.1}Ga_{0.85}N_{0.95}P_{0.05} which is an inorganic solid material was employed as a medium. Energy efficiency η and an average color rendering index Ra evaluated similarly to Example 1 were 80 [lm/W] and 85 respectively.

### EXAMPLE 13

Light-emitting device 100 of the example shown in FIG. 1 was prepared similarly to Example 1, except that ZnO which is an inorganic solid material was employed as a medium. Energy efficiency η and an average color rendering index Ra evaluated similarly to Example 1 were 75 [lm/W] and 85 respectively.

### EXAMPLE 14

Light-emitting device 100 of the example shown in FIG. 1 was prepared similarly to Example 1, except that MgO which is an inorganic solid material was employed as a medium. Energy efficiency η and an average color rendering index Ra evaluated similarly to Example 1 were 80 [lm/W] and 85 respectively.

### EXAMPLE 15

Light-emitting device 100 of the example shown in FIG. 1 was prepared similarly to Example 1, except that Zn_{0.95}Cd_{0.05}O which is an inorganic solid material was employed as a medium. Energy efficiency η and an average color rendering index Ra evaluated similarly to Example 1 were 75 [lm/W] and 85 respectively.

### EXAMPLE 16

Light-emitting device 100 of the example shown in FIG. 1 was prepared similarly to Example 1, except that Mg_{0.95}Zn_{0.05}O which is an inorganic solid material was employed as a medium. Energy efficiency η and an average color rendering index Ra evaluated similarly to Example 1 were 80 [lm/W] and 90 respectively.

### EXAMPLE 17

Light-emitting device 100 of the example shown in FIG. 1 was prepared similarly to Example 1, except that Mg_{0.95}Zn_{0.05}Cd_{0.05}O which is an inorganic solid material was employed as a medium. Energy efficiency η and an average color rendering index Ra evaluated similarly to Example 1 were 80 [lm/W] and 90 respectively.

### EXAMPLE 18

Light-emitting device 100 of the example shown in FIG. 1 was prepared similarly to Example 1, except that ZnS which is an inorganic solid material was employed as a medium. Energy efficiency η and an average color rendering index Ra evaluated similarly to Example 1 were 80 [lm/W] and 85 respectively.

### EXAMPLE 19

Light-emitting device 100 of the example shown in FIG. 1 was prepared similarly to Example 1, except that ZnS_{0.9}Se_{0.1} which is an inorganic solid material was employed as a medium. Energy efficiency η and an average color rendering index Ra evaluated similarly to Example 1 were 75 [lm/W] and 80 respectively.

### EXAMPLE 20

Light-emitting device 100 of the example shown in FIG. 1 was prepared similarly to Example 1, except that Y₂O₃ which is an inorganic solid material was employed as a medium. Energy efficiency η and an average color rendering index Ra evaluated similarly to Example 1 were 85 [lm/W] and 90 respectively.

### EXAMPLE 21

Light-emitting device 100 of the example shown in FIG. 1 was prepared similarly to Example 1, except that Al₂O₃ which is an inorganic solid material was employed as a medium. Energy efficiency η and an average color rendering index Ra evaluated similarly to Example 1 were 85 [lm/W] and 90 respectively.

### EXAMPLE 22

Light-emitting device 100 of the example shown in FIG. 1 was prepared similarly to Example 1, except that SiO₂ which is an inorganic solid material was employed as a medium. Energy efficiency η and an average color rendering index Ra evaluated similarly to Example 1 were 75 [lm/W] and 80 respectively.

### EXAMPLE 23

Light-emitting device 100 of the example shown in FIG. 1 was prepared similarly to Example 1, except that Ga₂O₃ which is an inorganic solid material was employed as a medium. Energy efficiency η and an average color rendering index Ra evaluated similarly to Example 1 were 85 [lm/W] and 90 respectively.

### EXAMPLE 24

Light-emitting device 100 of the example shown in FIG. 1 was prepared similarly to Example 1, except that Sc₂O₃ which is an inorganic solid material was employed as a medium. Energy efficiency η and an average color rendering index Ra evaluated similarly to Example 1 were 75 [lm/W] and 80 respectively.

### EXAMPLE 25

Light-emitting device 100 of the example shown in FIG. 1 was prepared similarly to Example 1, except that In₂O₃ which is an inorganic solid material was employed as a medium. Energy efficiency η and an average color rendering index Ra evaluated similarly to Example 1 were 80 [lm/W] and 85 respectively.

### EXAMPLE 26

Light-emitting device 100 of the example shown in FIG. 1 was prepared similarly to Example 1, except that α-SiAlON which is an inorganic solid material was employed as a medium. Energy efficiency η and an average color rendering index Ra evaluated similarly to Example 1 were 85 [lm/W] and 90 respectively.

1. A light-emitting device comprising a semiconductor excitation light source emitting blue-violet light and a solid material illuminant having an absorbent for said blue-violet light containing Sm, wherein
said solid material illuminant absorbs blue-violet light with said semiconductor excitation light source by Sm contained in the absorbent and radiates light by inner shell transition of Sm.

2. The light-emitting device according to claim 1, wherein
said blue-violet light has a peak wavelength in the range of 398 to 412 nm.

3. The light-emitting device according to claim 2, wherein
said semiconductor excitation light source emitting blue-violet light is a semiconductor laser device having an active layer of an InGaN semiconductor.

4. The light-emitting device according to claim 1, wherein
said solid material illuminant contains Sc, Y or a typical element as cations, and contains at least one of N, O and S as anions.

5. The light-emitting device according to claim 4, wherein
said solid material illuminant contains both N and O as anions.

6. The light-emitting device according to claim 4, wherein
said solid material illuminant contains at least one of nitrides of Ga, In and Al.

7. The light-emitting device according to claim 4, wherein
said solid material illuminant contains at least one of oxides of Y, Si, Al and Zn.

8. The light-emitting device according to claim 1, wherein
said solid material illuminant contains a red phosphor having a peak wavelength in the range of 600 to 670 nm, a green phosphor having a peak wavelength in the range of 500 to 550 nm and a blue phosphor having a peak wavelength in the range of 450 to 480 nm.

9. The light-emitting device according to claim 8, wherein
said red phosphor, said green phosphor and said blue phosphor contain rare earth elements.

10. The light-emitting device according to claim 8, wherein
said red phosphor contains at least Sm or Eu.
